(19) United States
(12) Patent Application Publication
(10) Pub. No.: US 2024/0402541 A1
(43) Pub. Date: Dec. 5, 2024

(54) DISPLAY DEVICE

(71) Applicant: E Ink Holdings Inc., Hsinchu (TW)

(72) Inventors: Ting-Yung Lai, Hsinchu (TW); Chen Yun Ma, Hsinchu (TW); Chi Meng Wu, Hsinchu (TW)

(73) Assignee: E Ink Holdings Inc., Hsinchu (TW)

(21) Appl. No.: 18/638,587

(22) Filed: Apr. 17, 2024

(30) Foreign Application Priority Data
May 30, 2023 (TW) 112120092

(51) Int. Cl. G02F 1/1339; G02F 1/167; G02F 1/1676

(52) U.S. Cl. CPC G02F 1/1339; G02F 1/167; G02F 1/1676; G02F 2202/28

(57) ABSTRACT

A display device including a first substrate, a second substrate, a display layer, and a sealing glue is provided. The first substrate includes a conductive pad. The second substrate is opposite to the first substrate. The display layer is disposed between the first substrate and the second substrate. The sealing glue is disposed between the first substrate and the second substrate and surrounds the display layer. The sealing glue has a conductive portion, and the conductive portion is in contact with the conductive pad.

### CROSS-REFERENCE TO RELATED APPLICATION

This application claims the priority benefit of Taiwan application serial no. 112120092, filed on May 30, 2023. The entirety of the above-mentioned patent application is hereby incorporated by reference herein and made a part of this specification.

### BACKGROUND

### Technical Field

The disclosure relates to an electronic device, and in particular to a display device.

### Description of Related Art

Preventing moisture intrusion is always a problem that needs to be improved in display device. In some display device designs, conductive glue, such as silver glue, may be used to connect the conductive structures disposed on two opposite substrates. However, the current conductive glue cannot provide sufficient water vapor barrier effect, so it is necessary to apply a sufficient width of frame glue outside the conductive glue to truly achieve the water vapor barrier effect.

### SUMMARY

The disclosure provides a display device, the sealing glue of which has electrical conductivity and sufficient sealing performance to achieve electrical conductivity and water vapor barrier effect.

The display device of the disclosure includes a first substrate, a second substrate, a display layer, and a sealing glue. The first substrate includes a conductive pad. The second substrate is opposite to the first substrate. The display layer is disposed between the first substrate and the second substrate. The sealing glue is disposed between the first substrate and the second substrate and surrounds the display layer. The sealing glue has a conductive portion, and the conductive portion is in contact with the conductive pad.

In an embodiment of the disclosure, the sealing glue also has a sealed portion. The sealed portion surrounds the conductive portion and the display layer.

In an embodiment of the disclosure, the material of the sealing glue as a whole includes a sealing material.

In an embodiment of the disclosure, the conductive portion further includes conductive particles. The conductive particles are distributed in the sealing material.

In an embodiment of the disclosure, the water vapor transmission rate (WVTR) of the sealing glue is 5 grams·mil/100 inches²·day to 68 grams·mil/100 inches²·day.

In an embodiment of the disclosure, the second substrate includes an electrode layer, and the conductive portion is in contact with the electrode layer.

In an embodiment of the disclosure, the electrode layer and the conductive pad are electrically connected through the conductive portion.

In an embodiment of the disclosure, the material of the sealing glue as a whole includes a sealing material and the conductive particles distributed in the sealing material.

In an embodiment of the disclosure, the resistivity of the conductive portion is less than 5×10⁻⁴ ohm·cm.

In an embodiment of the disclosure, the display layer includes an electronic paper display layer.

In an embodiment of the disclosure, the width of the sealing glue measured from the conductive portion outward to the outer edge of the sealing glue is 0 mm to 0.5 mm.

Based on the above, the display device of the embodiment of the disclosure uses a sealing glue to surround the display layer, and the sealing glue includes a conductive portion that can conduct electricity. In this way, the sealing glue can have both the functions of water vapor barrier and electrical conductivity, and the sealing glue does not need to be widened at a specific position, which helps achieve a narrow frame design.

### BRIEF DESCRIPTION OF THE DRAWINGS

FIG. 1 is a schematic view of a display device according to an embodiment of the disclosure.

FIG. 2 is a schematic cross-sectional view of the display device in FIG. 1 along a line I-I.

FIG. 3 is a schematic cross-sectional view of the display device in FIG. 1 along a line II-II.

FIG. 4 is a schematic view of a display device according to an embodiment of the disclosure.

FIG. 5 is a schematic cross-sectional view of the display device in FIG. 4 along a line III-III.

FIG. 6 is a schematic view of a display device according to an embodiment of the disclosure.

FIG. 7 is a schematic cross-sectional view of the display device in FIG. 6 along a line IV-IV.

FIG. 8 is a schematic view of a display device according to an embodiment of the disclosure.

FIG. 9 is a schematic cross-sectional view of the display device in FIG. 8 along a line V-V.

### DESCRIPTION OF THE EMBODIMENTS

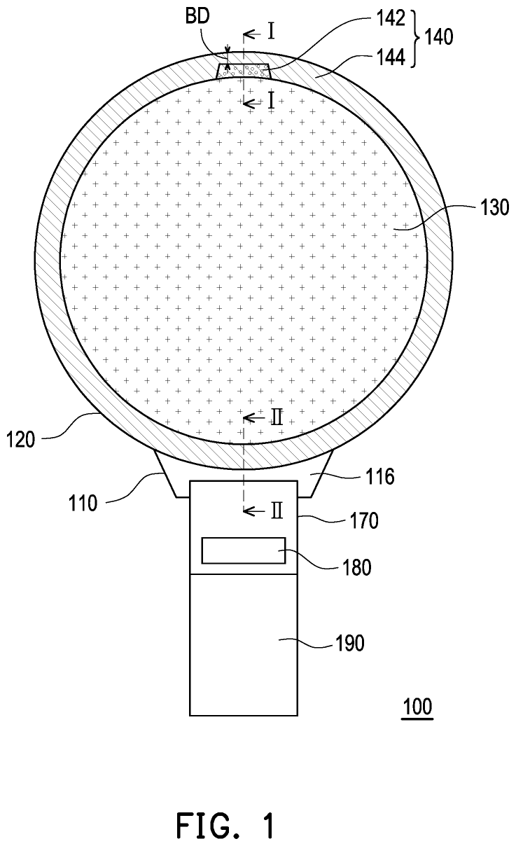

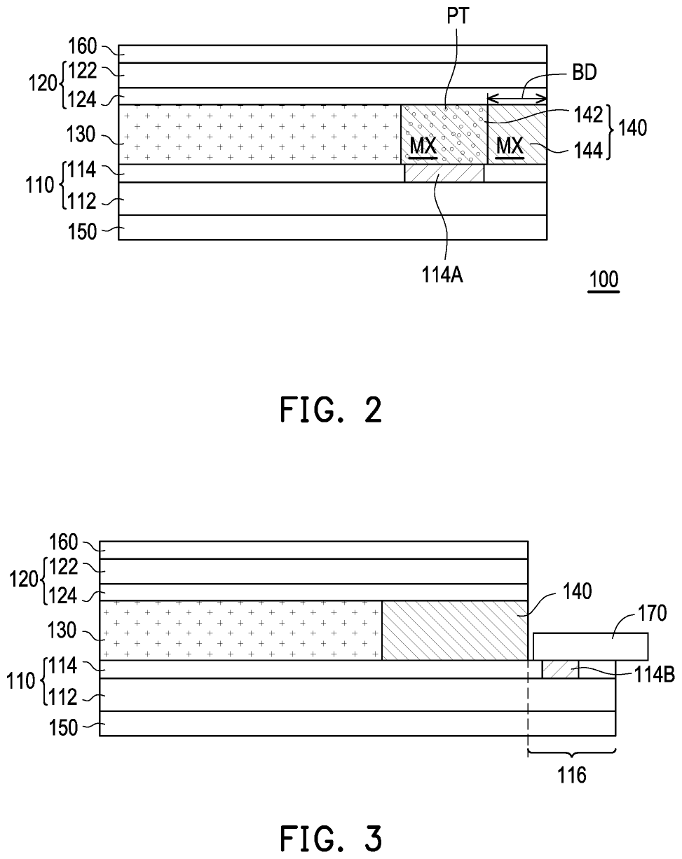

FIG. 1 is a schematic view of a display device according to an embodiment of the disclosure, FIG. 2 is a schematic cross-sectional view of the display device in FIG. 1 along a line I-I, and FIG. 3 is a schematic cross-sectional view of the display device in FIG. 1 along a line II-II. Referring to FIG. 1 to FIG. 3, a display device 100 includes a first substrate 110, a second substrate 120, a display layer 130, and a sealing glue 140. The first substrate 110 is disposed opposite to the second substrate 120. The display layer 130 is disposed between the first substrate 110 and the second substrate 120. The sealing glue 140 is disposed between the first substrate 110 and the second substrate 120 and surrounds the display layer 130. The sealing glue 140 may completely surround the display layer 130, so that the display layer 130 is sealed in an enclosed space surrounded by the first substrate 110, the second substrate 120, and the sealing glue 140.

The first substrate 110 may be an active component array substrate, and may include a first supporting layer 112 and an active component circuit layer 114. The first supporting layer 112 may be a glass substrate, a plastic substrate and other supportive plate-like components, and the first supporting layer 112 may be used to maintain the appearance of the display device 100. The active component circuit layer 114 is disposed on the first supporting layer 112 and positioned between the first supporting layer 112 and the display layer 130. In order to realize the required circuit function, the active component circuit layer 114 may include components such as signal lines, active components, capacitors, and a conductive pad 114A, and may comprise at least one semiconductor pattern layer, multiple conductive layers, and multiple insulation layers. For the convenience of illustration, FIG. 2 simplifies the structure of the active component circuit layer 114, and only schematically shows the conductive pad 114A. The conductive pad 114A may be positioned outside the display layer 130 and not covered by the display layer 130. Additionally, the sealing glue 140 may be in contact with the conductive pad 114A.

The second substrate 120 may be an electrode substrate, and may include a second supporting layer 122 and an electrode layer 124. The second supporting layer 122 is, for example, a flexible substrate, such as PET substrate, PI substrate, or other flexible substrates. The second supporting layer 122 and the electrode layer 124 may have a good light transmittance, so as to allow the display light of the display device 100 to pass through the second substrate 120 for users to watch. The electrode layer 124 is positioned between the second supporting layer 122 and the display layer 130. The electrode layer 124 and the active component circuit layer 114 of the first substrate 110 may be used to establish a driving electric field to drive the display medium in the display layer 130 to perform display. The electrode layer 124 may exceed the display layer 130, and the sealing glue 140 may be in contact with the electrode layer 124.

The display layer 130 may be a member encapsulating a display medium (not shown) into a layer. The display medium may include electrophoretic display materials, electrowetting display materials, or other display materials. The display layer 130 may encapsulate the display medium by adopting a microcup structure, a microcapsule structure, and the like. For example, the display layer 130 may be an electronic paper display layer, but is not limited thereto. In this embodiment, the outline of the second substrate 120 may roughly correspond to the outline of the display layer 130, for example, both are formed in a circle shape.

Both the first substrate 110 and the second substrate 120 exceed the display layer 130, and the sealing glue 140 disposed between the first substrate 110 and the second substrate 120 surrounds the display layer 130. The sealing glue 140 may have a conductive portion 142. As shown in FIG. 2, the conductive portion 142 overlaps the conductive pad 114A of first substrate 110. Specifically, the conductive portion 142 may be in contact with the conductive pad 114A of the first substrate 110, and may also be in contact with the electrode layer 124 of the second substrate 120. In this embodiment, the sealing glue 140 also has a sealed portion 144, and the sealed portion 144 surrounds the conductive portion 142 and the display layer 130. As shown in FIG. 1 and FIG. 2, the conductive portion 142 may be positioned between the sealed portion 144 and the display layer 130 and covered by the sealed portion 144. That is to say, the conductive portion 142 may not be exposed, but is not limited thereto. In some embodiments, a width BD of the sealing glue 140 measured from the conductive portion 142 outward to the outer edge of the sealing glue 140 may range from approximately 0 mm to 0.5 mm, so as to achieve a narrow frame design.

The material of the sealing glue 140 as a whole includes a sealing material MX. In some embodiments, the sealing material MX includes organic resins such as epoxy resins, polyurethane resins, furan-base resins, acrylic resins, or other similar resins. The water vapor transmission rate (WVTR) of the sealing glue 140 at 50° C. and 100% relative humidity is 5 grams ·mil/100 inches²·day (g·mil/100 in²·day) to 68 grams·mil/100 inches²·day. In some embodiments, the sealing material MX may further include fillers, such as small-sized particles such as glass fibers, which help increase the mechanical strength of the sealing material MX.

In this embodiment, the conductive portion 142 further includes conductive particles PT, and the conductive particles PT are distributed in the sealing material MX. Meanwhile, the sealed portion 144 mainly includes the sealing material MX. That is, the resistivity of the conductive portion 142 is lower than the sealed portion 144. The conductive particles PT in the conductive portion 142 may include materials having a good electrical conductivity such as silver, copper, or gold. In some embodiments, the conductive particles PT may account for 70% wt to 80% wt of the conductive portion 142. The resistivity of the conductive portion 142 is less than 5×10⁻⁴ ohm·cm, so as to provide the function of electric conduction. The conductive pad 114A of the first substrate 110 and the electrode layer 124 of the second substrate 120 may be electrically connected through the conductive portion 142. In this way, the electrode layer 124 of the second substrate 120 may receive the corresponding driving signal to realize the display function.

The matrix material of the conductive portion 142 is the sealing material MX, and the sealing material MX has a small WVTR. In some embodiments, the WVTR of the conductive portion 142 at 50° C. and 100% relative humidity is, for example, 5 grams·mil/100 inches²·day (g·mil/100 in²·day) to 68 grams·mil/100 inches²·day. Therefore, in addition to providing electrical conductivity, the conductive portion 142 may also has a water vapor barrier effect. In this embodiment, both the conductive portion 142 and the sealed portion 144 have a good water vapor barrier ability. The sealing glue 140 does not need to be widened at the conductive portion 142, which helps achieve a narrow frame design. In some embodiments, the display layer 130 may, as shown in FIG. 1, have an outer outline formed in a perfect circle shape, and the sealing glue 140 as a whole may have a substantially uniform width, but is not limited thereto.

As shown in FIG. 2 and FIG. 3, the display device 100 further includes a first function layer 150 and a second function layer 160, and the first function layer 150 and the second function layer 160 are disposed outside the first substrate 110 and the second substrate 120 respectively. The first function layer 150 and the second function layer 160 may optionally provide required functions, such as water vapor barrier function, optical adjustment function, to improve the quality of the display device 100.

In addition, as shown in FIG. 1 and FIG. 3, the display device 100 also includes a circuit board 170, a driving circuit 180, and a printed circuit board 190. The circuit board 170 is joined to the first substrate 110, the driving circuit 180 is joined to the circuit board 170, and the printed circuit board 190 is joined to the circuit board 170. For example, the first substrate 110 may include a protruding portion 116 exceeding the second substrate 120, and the circuit board 170 may be joined to the protruding portion 116. The active component circuit layer 114 of the first substrate 110 further includes a joining pad 114B positioned at the protruding portion 116, and the circuit board 170 may be joined to the joining pad 114B. In this way, the printed circuit board 190 and the driving circuit 180 may be electrically connected to the first substrate 110 through the circuit board 170. Meanwhile, the printed circuit board 190 and the driving circuit 180 may be electrically connected to the electrode layer 124 of the second substrate 120 through the circuit board 170, the first substrate 110, and the conductive portion 142 of the sealing glue 140.

In FIG. 1, the first substrate 110 of the display device 100 generally presents an outline formed in a circle shape except for the protruding portion 116. At the same time, the display layer 130 and the second substrate 120 also generally present an outline formed in a circle shape. Therefore, the display device 100 may provide a display area formed in a circle shape, and the display device 100 may generally have an outline designed to form in a circle shape except for the protruding portion 116 joining the circuit board 170 because the sealing glue 140 does not need to be additionally widened at the conductive portion 142.

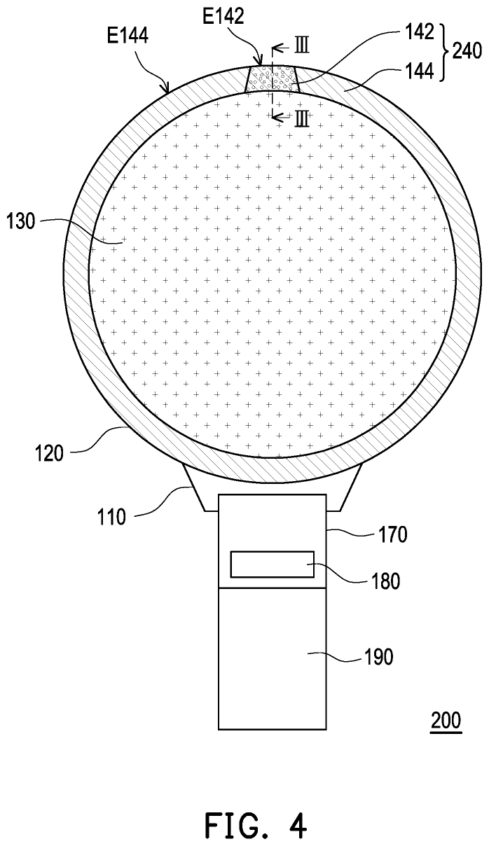

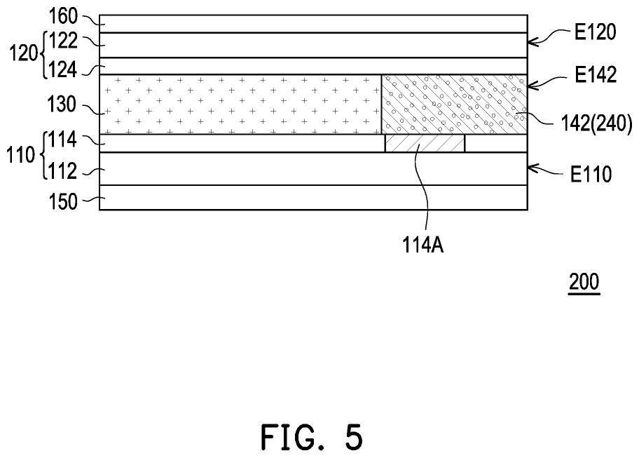

FIG. 4 is a schematic view of a display device according to an embodiment of the disclosure, and FIG. 5 is a schematic cross-sectional view of the display device in FIG. 4 along a line III-III. Referring to FIG. 4, a display device 200 includes the first substrate 110, the second substrate 120, the display layer 130, and a sealing glue 240, in which the first substrate 110 includes the first supporting layer 112 and the active component circuit layer 114, and the second substrate 120 includes the second supporting layer 122 and the electrode layer 124. The display device 200 is substantially the same as the display device 100, and the display device 200 may further include the first function layer 150, the second function layer 160, the circuit board 170, the driving circuit 180, and the printed circuit board 190, the first substrate 110, the second substrate 120, the display layer 130, the first function layer 150, the second function layer 160, the circuit board 170, the driving circuit 180, and the printed circuit board 190 may refer to the descriptions in FIG. 1 to FIG. 3. The difference between the display device 200 and the display device 100 lies in the structure of the sealing glue 240.

Specifically, the sealing glue 240 may include a conductive portion 142 and the sealed portion 144, and the conductive portion 142 may be in contact with the conductive pad 114A of the first substrate 110 and the electrode layer 124 of the second substrate 120, and is used to electrically connect the conductive pad 114A to the electrode layer 124. In this embodiment, an outer edge E142 of the conductive portion 142 and an outer edge E144 of the sealed portion 144 may be continuous with each other to surround an outer outline of the sealing glue 140. Viewing from the cross-section of the line III-III, the outer edge E142 of the conductive portion 142 may be aligned with an edge E110 of the first substrate 110 and may also be aligned with an edge E120 of the second substrate 120. In another cross-section not shown, the outer edge E144 of the sealed portion 144 may also be aligned with the edge E110 of the first substrate 110 and be aligned with the edge E120 of the second substrate 120.

Since the conductive portion 142 and the sealed portion 144 mainly comprise sealing material, a good water vapor barrier effect can be provided. Therefore, the conductive portion 142 itself can provide a sealing effect, and no additional sealing material is disposed outside the conductive portion 142, which helps reduce the width of the frame of the display device 200 on the conductive portion 142. In some embodiments, the sealing glue 240 may have a uniform width substantially following the outline of the display layer 130. When the display device 200 is designed in various shapes, the display layer 130 may also have a corresponding shape, thereby increasing the design flexibility of the display device 200.

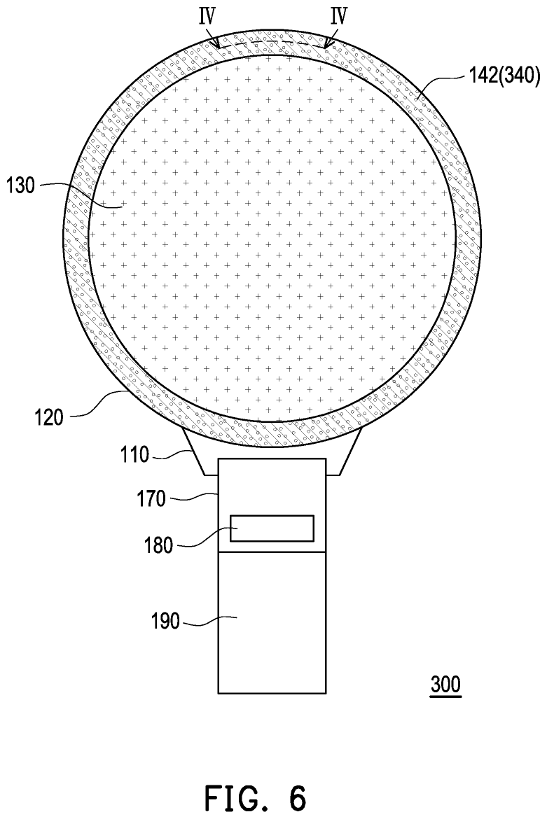

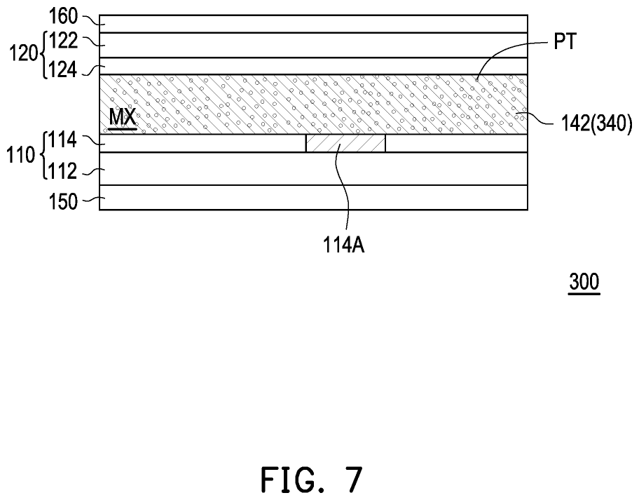

FIG. 6 is a schematic view of a display device according to an embodiment of the disclosure, and FIG. 7 is a schematic cross-sectional view of the display device in FIG. 6 along a line IV-IV. Referring to FIG. 6 and FIG. 7, a display device 300 includes the first substrate 110, the second substrate 120, the display layer 130, and a sealing glue 340, in which the first substrate 110 includes the first supporting layer 112 and the active component circuit layer 114, and the second substrate 120 includes the second supporting layer 122 and the electrode layer 124. The display device 300 is substantially the same as the display device 100, and the display device 300 may further include the first function layer 150, the second function layer 160, the circuit board 170, the driving circuit 180, and the printed circuit board 190, the first substrate 110, the second substrate 120, the display layer 130, the first function layer 150, the second function layer 160, the circuit board 170, the driving circuit 180, and the printed circuit board 190 may refer to the descriptions in FIG. 1 to FIG. 3. The difference between the display device 300 and the display device 100 lies in the structure of the sealing glue 340.

The sealing glue 340 has the conductive portion 142, and specifically, the sealing glue 340 as a whole comprise the conductive portion 142. In other words, the material of the sealing glue 340 as a whole includes the sealing material MX and the conductive particles PT distributed in the sealing material MX. In some embodiments, the conductive particles PT may include materials having a good electrical conductivity such as silver, copper, or gold, and the conductive particles PT in the sealing glue 340 may account for 70% wt to 80% wt of the sealing glue 340. In some embodiments, the resistivity of the sealing glue 340 as a whole may be less than 5×10⁻⁴ ohm·cm.

The sealing glue 340 may be in contact with the conductive pad 114A of the first substrate 110 and the electrode layer 124 of the second substrate 120, and is used to electrically connect the conductive pad 114A to the electrode layer 124. The conductive member in contact with the sealing glue 340 may only include the conductive pad 114A and the electrode layer 124, so the sealing glue 340 as a whole has a low electrical conductivity but does not cause unwanted short circuits. In addition, the WVTR of the sealing glue 340 at 50° C. and 100% relative humidity is 5 grams·mil/100 inches²·day (g·mil/100 in²·day) to 68 grams·mil/100 inches²·day. Therefore, a good water vapor barrier effect can be provided, thereby reducing the probability of deterioration and/or damage of the display layer 130 due to intrusion of water vapor.

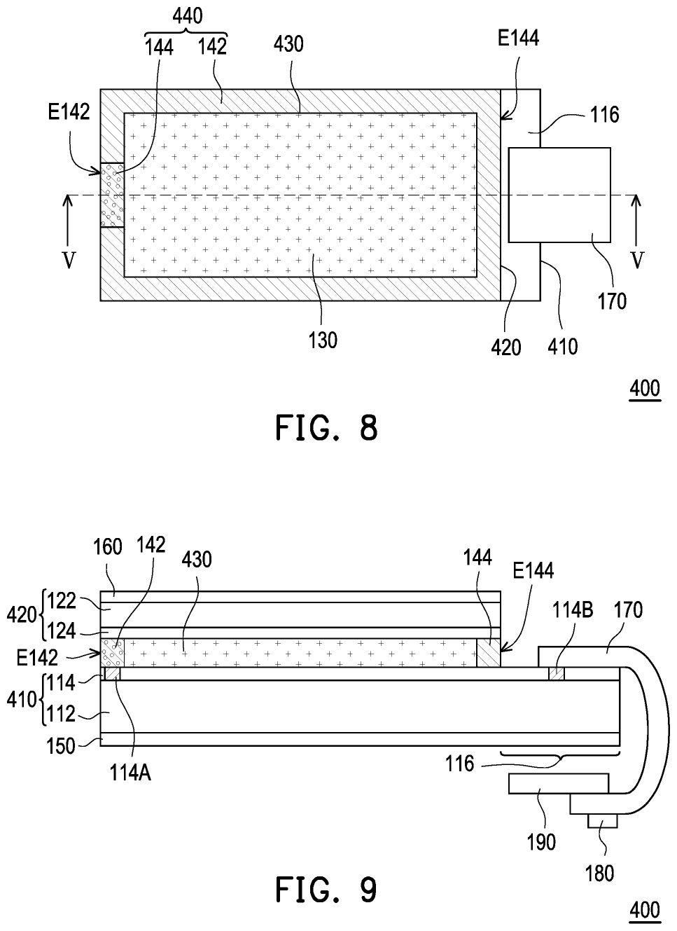

FIG. 8 is a schematic view of a display device according to an embodiment of the disclosure, and FIG. 9 is a schematic cross-sectional view of the display device in FIG. 8 along a line V-V. Referring to FIG. 8 and FIG. 9, a display device 400 includes a first substrate 410, a second substrate 420, a display layer 430, and a sealing glue 440, in which the first substrate 410 includes the first supporting layer 112 and the active component circuit layer 114, and the second substrate 420 includes the second supporting layer 122 and the electrode layer 124. The display device 400 is substantially the same as the display device 100, and the display device 400 may further include the first function layer 150, the second function layer 160, the circuit board 170, the driving circuit 180, and the printed circuit board 190, in which the first supporting layer 112, the active component circuit layer 114, the second supporting layer 122, the electrode layer 124, the first function layer 150, the second function layer 160, the circuit board 170, the driving circuit 180, and the printed circuit board 190 may refer to the descriptions in FIG. 1 to FIG. 3.

The first substrate 410, the second substrate 420, the display layer 430, and the sealing glue 440 are substantially the same in materials, properties, and relative configurations as the first substrate 110, the second substrate 120, the display layer 130, and the sealing glue 140 as described in FIG. 1 to FIG. 3. Therefore, the descriptions of FIG. 1 to FIG. 3 are applicable to the embodiments of FIG. 8 and FIG. 9. The display device 400 is different from the display device 100 in the shapes of the first substrate 410, the second substrate 420, the display layer 430, and the sealing glue 440. Specifically, the first substrate 410, the second substrate 420, the display layer 430, and the sealing glue 440 of the display device 400 are formed in a rectangular shape. The first substrate 410 partially exceeds the second substrate 420 to have the protruding portion 116, and the circuit board 170 is joined to the protruding portion 116.

In this embodiment, the first substrate 410 and the second substrate 420 are disposed opposite to each other. The display layer 430 is disposed between the first substrate 410 and the second substrate 420. Both the first substrate 410 and the second substrate 420 exceed the display layer 430, and the sealing glue 440 disposed between the first substrate 410 and the second substrate 420 surrounds the display layer 430, so that the display layer 430 is sealed in an enclosed space surrounded by the first substrate 410, the second substrate 420, and the sealing glue 440. The sealing glue 440 may have the conductive portion 142 and the sealed portion 144, and the sealed portion 144 and the conductive portion 142 completely surround the display layer 130.

The material of the sealing glue 440 as a whole includes the sealing material MX, and the conductive portion 142 also includes the conductive particles PT, in which the conductive particles PT are distributed in the sealing material MX. The WVTR of the sealing glue 440 as a whole at 50° C. and 100% relative humidity is 5 grams·mil/100 inches²·day (g·mil/100 in²·day) to 68 grams·mil/100 inches²·day. The outer edge E142 of the conductive portion 142 and the outer edge E144 of the sealed portion 144 may be continuous with each other to surround an outer outline of the sealing glue 440. The outer edge E142 of the conductive portion 142 may be aligned with the edge of the first substrate 410 or the edge of the second substrate 420, and the outer edge E144 of the sealed portion 144 may be aligned with the edge of the second substrate 420. In other sections, the outer edge E144 of the sealed portion 144 may also be aligned with the edge of the first substrate 410.

The active component circuit layer 114 of the first substrate 410 includes the conductive pad 114A and the joining pad 114B. The conductive portion 142 is in contact with the conductive pad 114A and is in contact with the electrode layer 124 of the second substrate 420 to realize the electrical connection between the electrode layer 124 and the conductive pad 114A. The joining pad 114B is positioned at the protruding portion 116, and the circuit board 170 is joined to the joining pad 114B. The disposed positions of the conductive pad 114A and the conductive portion 142 in FIG. 8 are only for illustration. In other embodiments, the conductive pad 114A and the conductive portion 142 may be positioned elsewhere on the sealing glue 440. If the conductive portion 142 is positioned at the protruding portion 116, the outer edge E142 of the conductive portion 142 may not be aligned with the edge of the first substrate 110.

In summary, the display device of the embodiment of the disclosure uses a sealing glue having a conductive portion to surround the display layer, so as to provide dual functions of water vapor barrier and electrical conductivity. Since the conductive portion of the sealing glue has a good water vapor barrier property, it is not necessary to widen the disposed width of the sealing glue at the conductive portion, which helps the design and application of a narrow frame.

What is claimed is:

1. A display device, comprising:
a first substrate comprising a conductive pad;
a second substrate opposite to the first substrate;
a display layer disposed between the first substrate and the second substrate; and
a sealing glue disposed between the first substrate and the second substrate and surrounding the display layer, wherein the sealing glue has a conductive portion, and the conductive portion is in contact with the conductive pad.

2. The display device according to claim 1, wherein the sealing glue further has a sealed portion, and the sealed portion surrounds the conductive portion and the display layer.

3. The display device according to claim 2, wherein a material of the sealing glue comprises a sealing material, the conductive portion comprises conductive particles, and the conductive particles are distributed in the sealing material.

4. The display device according to claim 3, wherein the conductive particles account for 70% wt to 80% wt of the sealing glue.

5. The display device according to claim 4, wherein a material of the conductive particles is selected from silver, copper, or gold.

6. The display device according to claim 1, wherein a water vapor transmission rate (WVTR) of the sealing glue is 5 grams·mil/100 inches²·day to 68 grams·mil/100 inches²·day.

7. The display device according to claim 1, wherein the second substrate comprises an electrode layer, and the conductive portion is in contact with the electrode layer.

8. The display device according to claim 7, wherein the electrode layer and the conductive pad are electrically connected through the conductive portion.

9. The display device according to claim 1, wherein a resistivity of the conductive portion is less than 5×10⁻⁴ ohm·cm.

10. The display device according to claim 1, wherein a width of the scaling glue measured from the conductive portion outward to an outer edge of the scaling glue is 0 mm to 0.5 mm.
